(19) United States
(12) Patent Application Publication
(10) Pub. No.: US 2023/0362996 A1
(43) Pub. Date: Nov. 9, 2023

(54) LOW LATENCY DECODE-AND-FORWARD (DF) RELAYING FOR A WIRELESS NETWORK

(71) Applicant: NXP USA, Inc., Austin, TX (US)

(72) Inventors: Rui Cao, Sunnyvale, CA (US); Liwen Chu, San Ramon, CA (US); Hongyuan Zhang, Fremont, CA (US)

(21) Appl. No.: 18/144,595

(22) Filed: May 8, 2023

Related U.S. Application Data
(60) Provisional application No. 63/364,288, filed on May 6, 2022.
(60) Provisional application No. 63/373,664, filed on Aug. 26, 2022.

(51) Int. Cl. H04W 74/08; H04L 5/00

(52) U.S. Cl. CPC H04W 74/0816; H04L 5/0053

(57) ABSTRACT

Embodiments of a method and apparatus for wireless communications are disclosed. In an embodiment, a wireless relay device includes a wireless transceiver configured to receive, from a source wireless device, communications data, and a controller configured to decode and forward the received communications data to at least one destination wireless device.

### CROSS-REFERENCE TO RELATED APPLICATIONS

This application is entitled to the benefit of U.S. Provisional Patent Application Ser. No. 63/364,288, filed on May 6, 2022, and U.S. Provisional Patent Application Ser. No. 63/373,664, filed on Aug. 26, 2022, each of which is incorporated by reference herein.

### BACKGROUND

Wireless communications devices, e.g., access points (APs) or non-AP devices can transmit various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). Some applications, for example, high definition (HD) video surveillance applications, outdoor video sharing applications, etc., require relatively high system throughput as well as good network coverage. However, typical range extension (ER) techniques provide limited wireless transmission range extension with a reduced data rate.

### SUMMARY

Embodiments of a method and apparatus for wireless communications are disclosed. In an embodiment, a wireless relay device includes a wireless transceiver configured to receive, from a source wireless device, communications data, and a controller configured to decode and forward the received communications data to at least one destination wireless device. Other embodiments are also disclosed.

In an embodiment, the wireless transceiver is further configured to share a transmit opportunity (TXOP) of the source wireless device.

In an embodiment, the wireless transceiver is further configured to share the TXOP of the source wireless device in a multi-hop transmission, where the multi-hop transmission is conducted through an aggregated physical layer protocol data unit (PPDU).

In an embodiment, the aggregated PPDU includes a first PPDU and a second PPDU that is a relayed version of the first PPDU, where a Legacy Signal Field (L-SIG) length of the first PPDU covers an entire aggregated PPDU transmission, and where the second PPDU includes a compressed preamble.

In an embodiment, the controller is further configured to forward all Media Access Control (MAC) protocol data units (MPDUs) without checking frame check sequence (FCS).

In an embodiment, the controller is further configured to check FCS and only forward correctly decoded MPDUs.

In an embodiment, the wireless relay device is compatible with an IEEE 802.11 protocol.

In an embodiment, the wireless relay device is a dedicated relay device.

In an embodiment, the wireless relay device is a non-access point (AP) wireless station with a relaying function enabled.

In an embodiment, the wireless relay device is an AP with a relaying function enabled or a coordinated TXOP sharing function enabled.

In an embodiment, a method for wireless communications involves receiving, from a source wireless device, communications data using at least one wireless relay device and decoding and forwarding the received communications data to at least one destination wireless device using the at least one wireless relay device.

In an embodiment, the method further includes sharing a TXOP of the source wireless device with the at least one wireless relay device in a multi-hop transmission.

In an embodiment, the method further includes setting up an end-to-end block acknowledgement (BA) agreement between the destination wireless device and the source wireless device, including defining an end-to-end sequence number space between the destination wireless device and the source wireless device.

In an embodiment, the method further includes providing an end-to-end security setup between the destination wireless device and the source wireless device.

In an embodiment, the multi-hop transmission is conducted through an aggregated PPDU, where the aggregated PPDU includes a first PPDU and a second PPDU that is a relayed version of the first PPDU, where an L-SIG length of the first PPDU covers an entire aggregated PPDU transmission, and where the second PPDU includes a compressed preamble.

In an embodiment, the first PPDU is transmitted from the source wireless device to the at least one wireless relay device.

In an embodiment, the method further includes using a packet extension to cover a gap between the first PPDU and the second PPDU.

In an embodiment, the method further includes at the source wireless device, determining a plurality of transmission parameters for all relayed transmission and signaling the transmission parameters in a PPDU.

In an embodiment, the method further includes providing relaying signaling in each PPDU to be relayed, and where the relaying signaling is embedded in a physical layer (PHY) preamble or in a MAC header.

In an embodiment, a method for wireless communications includes receiving, from a source wireless device, communications data using a plurality of wireless relay devices that are compatible with an IEEE 802.11 protocol and decoding and forwarding the received communications data to at least one destination wireless device using the wireless relay devices, wherein a communications range of the source wireless device is extended and a communications throughput of the source wireless device is improved.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system with relay transmission capabilities in accordance with an embodiment of the invention.

FIG. 2 depicts a wireless communications system with Decode-and-Forward (DF) relay transmission capabilities in accordance with an embodiment of the invention.

FIG. 3 depicts a wireless DF relaying system in accordance with an embodiment of the invention.

FIG. 4 depicts a wireless DF single relay multi-hop communications system in accordance with an embodiment of the invention.

FIG. 5 depicts a wireless DF multi-relay cooperative communications system in accordance with an embodiment of the invention.

FIG. 6 depicts a wireless relay device in accordance with an embodiment of the invention.

FIG. 7 depicts a frame exchange sequence diagram between a transmission station, a relay station, and a destination station in accordance with an embodiment of the invention.

FIG. 8 depicts an aggregated physical layer protocol data unit (PPDU) in accordance with an embodiment of the invention.

FIG. 9 is a process flow diagram of a method for wireless communications in accordance with an embodiment of the invention.

FIG. 10 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

Range extension (ER) PPDU formats are introduced from IEEE 802.11ax and carried over to IEEE 802.11be and beyond. Direct sequence spread spectrum (DSSS) is also defined in IEEE 802.11b in 2.4 GHz band with longer range. However, these ER physical layer (PHY) modes can extend the transmission range with limited 3 dB-6 dB, and the sustainable data rate is reduced to 1˜3 mbps. Relay forwarding has been defined as independent transmission for each hop, which induced long latency and jitter. For example, typical WiFi extender/repeater/boosters have long end-to-end latency, high jitter, and low throughput. In a WiFi mesh router or EasyMesh program, each mesh router is interconnected with another mesh router through either wire or wireless. For wireless connection, every AP can relay the data from a master AP to its own stations (STAs). Each mesh node has a full function AP and at least one full function STA, thus is not cost effective. The AP relaying protocol is built on top of existing IEEE 802.11 Media Access Control (MAC)/PHY components, latency/jitter is also high compared to single-hop case. For IEEE 802.11 11ah/ad relaying mode, end to end latency and throughput may not be guaranteed with hop-by-hop block acknowledgement (BA)/acknowledgement (ACK) agreement and security protocol.

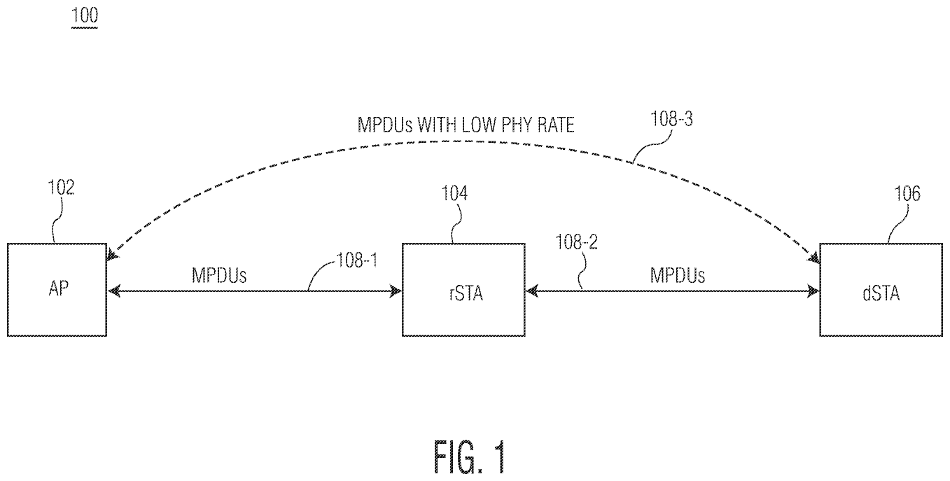

FIG. 1 depicts a wireless (e.g., WiFi) communications system 100 with relay transmission capabilities in accordance with an embodiment of the invention. In the embodiment depicted in FIG. 1, the wireless communications system 100 includes an AP 102, a relay station (STA) (rSTA) 104, and a destination STA (dSTA) 106. The rSTA is located between the AP and the dSTA and is configured to forward data to the dSTA. In some embodiments, the rSTA is configured to decode and forward data that is received from the AP 102 to the dSTA. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with one rSTA and one dSTA, multiple APs with multiple rSTAs and one dSTA, multiple APs with one rSTA and multiple dSTAs, multiple APs with multiple rSTAs and multiple dSTAs, one AP with one rSTA and multiple dSTAs, or one AP with multiple rSTAs and multiple dSTAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP 102, the rSTA 104, and the dSTA 106 communicate through single communications links. In some embodiments, the wireless communications system 100 described with reference to FIG. 1 involves multi-link communications and the AP 102, the rSTA 104, and the dSTA 106 communicate through multiple communications links. Furthermore, the techniques described herein may also be applicable to each link of a multi-link communications system.

In the embodiment depicted in FIG. 1, the AP 102 may be implemented in hardware (e.g., circuits), software, firmware, or a combination thereof. The AP 102 may be fully or partially implemented as an integrated circuit (IC) device. In some embodiments, the AP 102 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 102 (e.g., a controller or a transceiver of the AP 102) implements upper layer Media Access Control (MAC) functionalities (e.g., beacon acknowledgement establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, the rSTA 104 and the dSTA 106 may be implemented in hardware (e.g., circuits), software, firmware, or a combination thereof. The rSTA 104 and the dSTA 106 may be fully or partially implemented as IC devices. In some embodiments, at least one of the rSTA 104 and the dSTA 106 is a communications device compatible with at least one IEEE 802.11 protocol. In some embodiments, at least one of the rSTA 104 and the dSTA 106 is implemented in a laptop, a desktop personal computer (PC), a mobile phone, or other communications device that supports at least one WLAN communications protocol. In some embodiments, at least one of the rSTA 104 and the dSTA 106 implements a common MAC data service interface and a lower layer MAC data service interface. In some embodiments, each of the rSTA 104 and the dSTA 106 includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 102 communicates with the rSTA 104 via a communication link 108-1, and the rSTA 104 communicates with the dSTA 106 via a communication link 108-2. The rSTA is located between the AP and the dSTA to forward data to the dSTA (e.g., decode and forward data received from the AP to the dSTA). In some embodiments, data communicated between the AP, the rSTA, and the dSTA includes MAC protocol data units (MPDUs). An MPDU may include a frame header, a frame body, and a trailer with the MSDU payload encapsulated in the frame body. When data transfer is performed with two channel access, the system throughput of the wireless communications system 100 depicted in FIG. 1 is halved linearly. The rSTA provides flexibility to achieve higher rate with shorter communications links 108-1, 108-2. The AP 102 can directly communicate with the dSTA 106 via a communication link 108-3. Compared to the communications links 108-1, 108-2, the communication link 108-3 has two times of distance, which corresponds to around 8 dB propagation loss (2.7 decaying exponent). To maintain the communication link 108-3, 8 dB better sensitivity and new PHY design is needed, the data rate is reduced to around ⅛ and physical layer protocol data unit (PPDU) airtime increases by 8 times. Although the AP 102, the rSTA 104, and the dSTA 106 are depicted in FIG. 1 as wirelessly communicating to each other 108 via a corresponding communications link 108-1, 108-2, or 108-3, in other embodiments, the AP 102, the rSTA 104, and the dSTA 106 may wirelessly communicate to each other via multiple communication links.

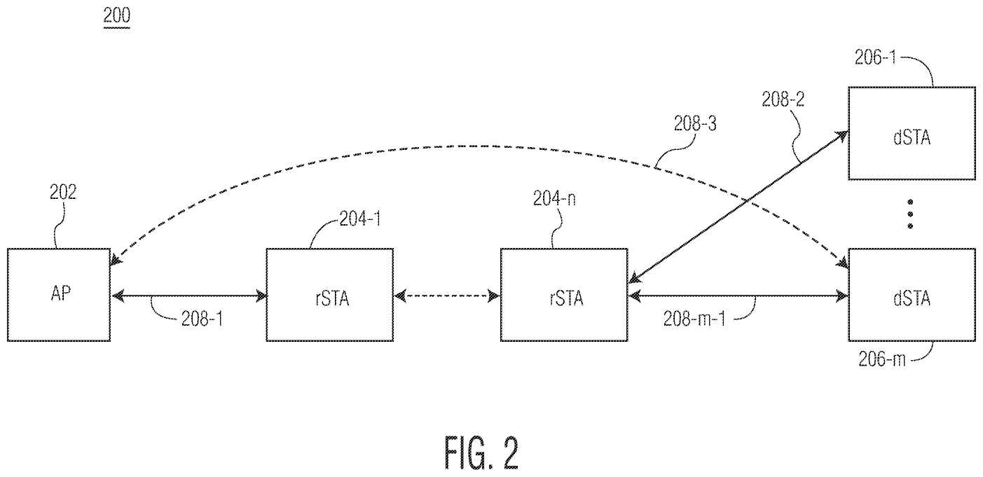

FIG. 2 depicts a wireless (e.g., WiFi) communications system 200 with Decode-and-Forward (DF) relay transmission capabilities in accordance with an embodiment of the invention. In the embodiment depicted in FIG. 2, the wireless communications system 200 includes an AP 202, a number of relay stations (STAs) (rSTAs) 204-1, . . . , 204-n, where n is a positive integer that is greater than one, and one or more destination STAs (dSTAs) 206-1, . . . , 206-m, where m is a positive integer. The rSTAs are located between the AP and the dSTA(s) and are configured to forward data to the dSTA(s). In some embodiments, the rSTAs are configured to decode and forward data received from the AP 202 to the dSTA(s). The wireless communications system can be used in various applications, such as industrial applications, medical applications, computer applications, and/or consumer or enterprise applications. In some embodiments, the wireless communications system is compatible with an IEEE 802.11 protocol. In the embodiment depicted in FIG. 2, the AP 202 may be implemented the same as or similar to the AP 102 depicted in FIG. 1, while the rSTAs 204-1, . . . , 204-n and the dSTA(s) 206-1, . . . , 206-m may be implemented the same as or similar to the rSTA 104 and the dSTA 106 depicted in FIG. 1, respectively. Although the depicted wireless communications system 200 is shown in FIG. 2 with certain components and described with certain functionality herein, other embodiments of the wireless communications system may include fewer or more components to implement the same, less, or more functionality. For example, although the wireless communications system is shown in FIG. 2 as being connected in a certain topology, the network topology of the wireless communications system is not limited to the topology shown in FIG. 2. In some embodiments, the wireless communications system 200 described with reference to FIG. 2 involves single-link communications and the AP, the rSTAs, and the dSTA(s) communicate through single communications links. In some embodiments, the wireless communications system 200 described with reference to FIG. 2 involves multi-link communications and the AP, the rSTAs, and the dSTA(s) communicate through multiple communications links. Furthermore, the techniques described herein may also be applicable to each link of a multi-link communications system.

In the embodiment depicted in FIG. 2, the AP 202 communicates with the rSTAs 204-1, . . . , 204-n via a communication link 208-1, and the rSTA 204-n communicates with the dSTA(s) 206-1, . . . , 206-m via a respective communication link 208-2, . . . , 208-m−1. The rSTAs 204-1, . . . , 204-n are located between the AP and the dSTA(s) 206-1, . . . , 206-m to forward data to the dSTA(s) 206-1, . . . , 206-m (e.g., decode and forward data received from the AP 202 to the dSTA(s)). In some embodiments, data communicated between the AP, the rSTAs, and the dSTA(s) includes MPDUs. An MPDU may include a frame header, a frame body, and a trailer with the MSDU payload encapsulated in the frame body. The rSTAs 204-1, . . . , 204-n provide flexibility to achieve higher rate with shorter communications links 208-1, . . . , 208-m−1. The AP 202 can directly communicate with the dSTA 206-m via a communication link 208-3. Compared to the communications links 208-1, . . . , 208-m−1, the communication link 208-3 has a longer distance, which corresponds to more propagation loss. Although the AP 202, the rSTAs 204-1, . . . , 204-n, and the dSTA(s) 206-1, . . . , 206-m are depicted in FIG. 2 as wirelessly communicating to each other via a corresponding communications link, in other embodiments, the AP 202, the rSTAs 204-1, . . . , 204-n, and the dSTA(s) 206-1, . . . , 206-m may wirelessly communicate to each other via multiple communication links.

To meet the requirement of high throughput longer range communications with latency guarantee, embodiments of low latency DF relaying techniques that can be used for next generation wireless networks (e.g., WiFi networks, such as, WiFi8 or Ultra High Reliability (UHR)) are described in details below. In accordance with an embodiment of the invention, a low-latency DF protocol is provided with Transmit opportunity (TXOP) sharing between a source node and a relay node, an end-to-end block acknowledgement (BA)/acknowledgement (ACK) agreement, physical (PHY) layer aggregated PPDU.

Consequently, the end-2-end latency and throughput is enhanced, and a cost-effective solution with enhanced communication reliability/throughput and range is provided. In some embodiments, a method for extending communications range uses one or more relay STAs. The method may further involve multi-hop transmission in a shared TXOP, which can provide or even guarantee lower latency. In some embodiments, at least one of the one or more relay STAs is an IEEE 802.11 device. In one embodiment, at least one of the one or more relay STAs is a dedicated relay device that serves long distance STAs. In another embodiment, at least one of the one or more relay STAs is a regular non-AP STA with the relaying function enabled. In another embodiment, at least one of the one or more relay STAs is an AP or a device functioning as an AP (also referred to as an uAP) with the relaying function enabled or coordinated TXOP sharing function enabled.

In some embodiments, relay communications path is generalized to a sequence of multiple relays (e.g., the rSTAs 204-1, . . . , 204-n) and data is transferred to one or more long range STAs (e.g., the dSTA(s) 206-1, . . . , 206-m). The wireless communications system 200 can operate under different operation modes. For example, under option 1, initial MPDUs are relayed in independent Transmit opportunity (TXOP) for each hop (e.g., each of the rSTAs 204-1, . . . , 204-n), while under option 2 (low latency mode), the initial MPDUs are relayed in shared TXOP for all hops (e.g., the rSTAs 204-1, . . . , 204-n). In some embodiments, TXOP defines the time duration for which a communications device can send data frames after the communications device gains contention for the transmission medium. In these embodiments, TXOP is a contention-free time period, which can increase the communications throughput of high priority data. In an embodiment, for a dSTA of the dSTA(s) 206-1, . . . , 206-m within beacon coverage, higher throughput with relaying is maintained, and for a dSTA out of beacon coverage, extended connection with low throughput is maintained.

The rSTAs 204-1, . . . , 204-n may be of various relay STA types. In some embodiments, at least one of the rSTAs 204-1, . . . , 204-n is implemented as a dedicated wireless (e.g., WiFi) relay device dedicated to assist one or more long range application STAs without in-device traffic. In some embodiment, a dedicated wireless (e.g., WiFi) relay device only includes MAC and PHY functionalities. For example, at least one of the rSTAs 204-1, . . . , 204-n is a dedicated wireless (e.g., WiFi) relay device that is low power and low cost without other functionality. In some embodiments, at least one of the rSTAs 204-1, . . . , 204-n is implemented as a device with regular wireless (e.g., WiFi) connectivity. For example, at least one of the rSTAs 204-1, . . . , 204-n may be a regular non-AP STA within the Basic Service Set (BSS) of the AP 202 or the extended service set (ESS) of the AP 202 and other AP(s) with relaying functionality enabled. In some embodiments, at least one of the rSTAs 204-1, . . . , 204-n is a simultaneous transmission and reception (STR) multi-link device (MLD) STA that relays on different communications links for low latency. In some embodiments, multiple-AP relaying is used and at least one of the rSTAs 204-1, . . . , 204-n is implemented as another AP or a device functioning as an AP (also referred to as an uAP) (e.g., a collaborating AP) while the AP 202 operates as a master AP. The master AP and the collaborating AP can share a TXOP to deliver the frame to a dSTA of the dSTA(s) 206-1, . . . , 206-m with low latency. In some embodiments, at least one of the rSTAs 204-1, . . . , 204-n is a STR MLD AP that relays on different communications links.

In some embodiments, under a low latency mode, relay TXOP is shared. For example, all hops for MPDUs transmission are finished within one TXOP. One STA obtaining TXOP can initiate a time sharing schedule among multiple STAs. In some embodiments, under DF mode, a relay node (e.g., one of the rSTAs 204-1, . . . , 204-n) decodes MPDUs and stores them in a special transmission (TX) buffer, and after some pre-determined or negotiated time (e.g., Short Interframe Spacing (SIFS)), a relay node retransmits the MPDUs to the destination or next hop. PPDU format may have two options. For example, under option 1, for any PPDU format, “relay mode” indication is in the MAC header. Under option 2, a new PPDU format or indication is in the PHY for the relay mode or ID. A relay node (e.g., one of the rSTAs 204-1, . . . , 204-n) may have power saving based on the PHY header.

One or more examples of relay frame construction are described as follows. In case 1, all far-away STAs are connected to last relay node (rSTA 204-n in FIG. 2) and rSTA_i connects with single rSTA_i+1 only. The frame with RA, TA, SA, DA is used. In Case 2: the far-away STAs are connected to any relay node (rSTA_i where i has value from 1 to n). The frame with RA, TA, SA, DA is used. Each relay node (e.g., one of the rSTAs 204-1, . . . , 204-n) has the addresses of the nodes that are connect with the relay node directly. The relay node (e.g., one of the rSTAs 204-1, . . . , 204-n) decides whether a received frame is forwarded to its connected relay node or the destination.

One or more examples of block acknowledgement (BA) procedure are described as follows. Under option 1 (hop-by-hop BA), an independent BA policy is set up for each hop as of one-hop communications between two STAs within an allocated TXOP. A relay STA (e.g., one of the rSTAs 204-1, . . . , 204-n) forwards only the correct MPDUs at the end of the TXOP, or only forwards data when all MPDUs are correctly received. A relay STA (e.g., one of the rSTAs 204-1, . . . , 204-n) may report link quality to assist TXOP sharing scheduling. Under option 2 (end-to-end BA), each relay (e.g., one of the rSTAs 204-1, . . . , 204-n) only forwards correct MPDUs without BA, and the dSTA to send BA and relayed backed to a source STA (sSTA), for example, the AP 202. sSTA BA timeout needs to be adjusted to accommodate the multi-hop scenario.

One or more examples of relay link setup are described as follows. In a hop by hop establishment, a STA establishes the association with its directly connected rSTA (e.g., one of the rSTAs 204-1, . . . , 204-n), and the rSTA notifies the STA that establishes the association with it. In association with AP approach, a STA's association with the AP is transparent to its direct connected rSTA (e.g., one of the rSTAs 204-1, . . . , 204-n), and the rSTA forwards the association frame without decoding the content of the frame.

One or more examples of TXOP sharing are described as follows. In some embodiments, a frame is transmitted from the AP 202 to a STA (e.g., one of the dSTA(s) 206-1, . . . , 206-m) through rSTA(s) (e.g., at least one of the rSTAs 204-1, . . . , 204-n) within one TXOP. In some embodiments, a frame is transmitted from a STA (e.g., one of the dSTA(s) 206-1, . . . , 206-m) to the AP 202 through rSTA(s) (e.g., at least one of the rSTAs 204-1, . . . , 204-n) within one TXOP. In some embodiments, a frame is transmitted from the AP 202 to a STA (e.g., one of the dSTA(s) 206-1, . . . , 206-m) through rSTA(s) (e.g., at least one of the rSTAs 204-1, . . . , 204-n) through multiple TXOPs. In some embodiments, a frame is transmitted from a STA (e.g., one of the dSTA(s) 206-1, . . . , 206-m) to the AP 202 through rSTA(s) (e.g., at least one of the rSTAs 204-1, . . . , 204-n) through multiple TXOPs.

One or more examples of relay power saving techniques are described as follows. In some embodiments, Target Wake Time (TWT) is synchronized among relay and destination devices (e.g., the rSTAs 204-1, . . . , 204-n and the dSTA(s) 206-1, . . . , 206-m). In some embodiments, a STA's doze, awake is known by its connected rSTA. In some embodiments, a STA's doze awake is known by its associated AP.

One or more examples of relay security techniques are described as follows. In some embodiments, hop-by-hop key creation is implemented in the wireless communications system 200. In some embodiments, key establishment is between the AP 202 and a STA. The rSTAs (e.g., the rSTAs 204-1, . . . , 204-n) in between do not encrypt/decrypt the received frames.

One or more examples of management frame relaying are described as follows. In some embodiments, if a relay STA is an AP or uAP, the relay STA processes management frames as an AP. In some embodiments, a relay STA forwards a received management frame without decoding the content of the received management frame.

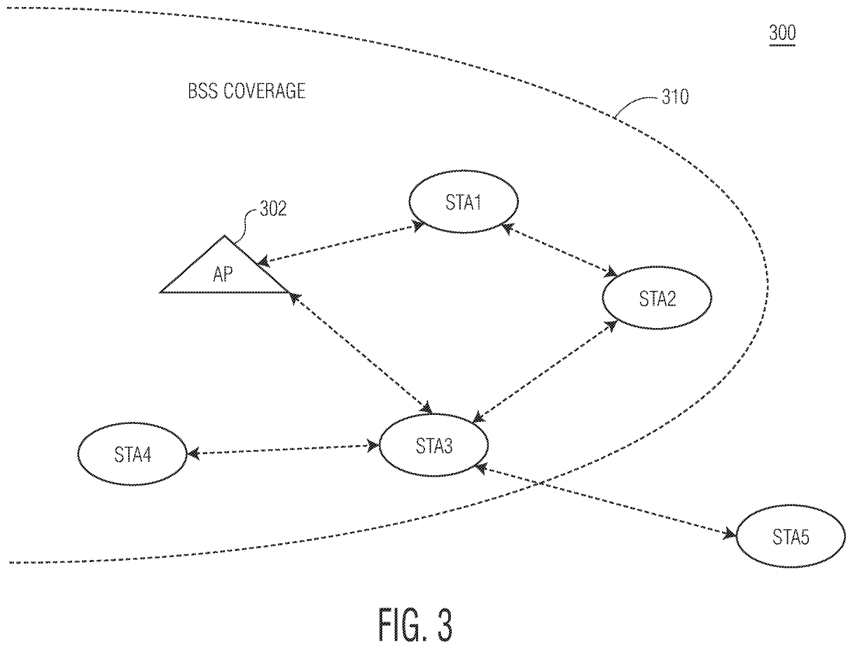

FIG. 3 depicts a wireless DF relaying system 300 in accordance with an embodiment of the invention. In the embodiment depicted in FIG. 3, the wireless DF relaying system 300 includes an AP 302 and five stations STA1, STA2, STA3, STA4, STA5. The AP 302 and the stations STA1, STA2, STA3, STA4 are located within a BSS 310 while the station STA5 is located outside the BSS 310. In some embodiments, the wireless DF relaying system 300 is compatible with an IEEE 802.11 protocol. Although the depicted wireless DF relaying system 300 is shown in FIG. 3 with certain components and described with certain functionality herein, other embodiments of the wireless communications system may include fewer or more components to implement the same, less, or more functionality. For example, although the wireless DF relaying system 300 is shown in FIG. 3 as being connected in a certain topology, the network topology of the wireless DF relaying system is not limited to the topology shown in FIG. 3. In addition, although the wireless DF relaying system 300 is shown in FIG. 3 as including one AP and five STAs, in other embodiments, the wireless DF relaying system may include multiple APs and/or more than or less than five STAs. In the embodiment depicted in FIG. 3, the AP 302 may be implemented the same as or similar to the AP 102 depicted in FIG. 1 and/or the AP 202 depicted in FIG. 2, while the stations STA1, STA2, STA3, STA4, STA5 may be implemented the same as or similar to the rSTA 104 and the dSTA 106 depicted in FIG. 1 and/or the rSTAs 204-1, . . . , 204-n and the dSTA(s) 206-1, . . . , 206-m depicted in FIG. 2.

In the embodiment depicted in FIG. 3, under a reliability/throughput enhancement mode, a source STA and a destination STA are within each other's communication range. At least each STA may be able to receive Modulation and Coding Scheme (MCS) from the other STA. The preamble of each other's PPDU can be detected/decoded. A relay has less pathloss to both the source and the destination, and thus signal-to-noise ratio (SNR) can be improved. The end-to-end reliability or throughput can be higher in multiple-hop communications. In a first example, AP→STA1→STA2, the AP 302 communicates with the station STA1, which communicates with the station STA2. Both the stations STA1 and STA2 are within the BSS range. The STA1 relays the AP's downlink (DL) traffic to the station STA2 to boost communication reliability and link efficiency. In a second example, STA4→STA3→STA2, the station STA4 communicates with the station STA3, which communicates with the station STA2. Point-to-point (P2P) links are used for the station STA4 and the station STA2, both within communications range of the station STA3. The station STA3 relays the station STA4's traffic to boost the station STA2's reliability and link efficiency.

In the embodiment depicted in FIG. 3, under a range extension mode, a source STA and a destination STA are not within each other's communication range in either direction, which may be due to the pathloss being too large, transmission (TX) power being un-balanced, smaller on one STA, or receiver (RX) sensitivity difference due to implementation or different interference level. A relay can help to retransmit the packet and thus extend the reach of the communications. In a first example, AP→STA3→STA5, the AP 302 communicates with the station STA3, which communicates with the station STA5. The station STA5 is out of the AP's one-hop communication range. The station STA3 relays the AP's DL traffic to the station STA5 to enhance coverage range. In a second example, STA4→STA3→STA5, the station STA4 communicates with the station STA3, which communicates with the station STA5. The station STA5 is out of the station STA4's one-hop communication range. The station STA3 helps to setup P2P link between the station STA4 and the station STA4, and relays the station STA4's traffic to the station STA5 to enhance P2P range.

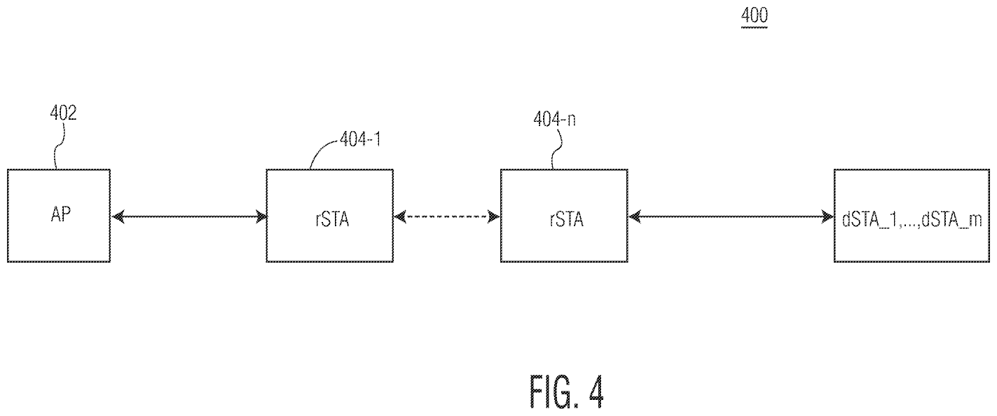

FIG. 4 depicts a wireless DF single relay multi-hop communications system 400 in accordance with an embodiment of the invention. In the embodiment depicted in FIG. 4, the wireless DF single relay multi-hop communications system 400 includes a source STA (sSTA) 402, relay stations (STAs) (rSTAs) 404-1, . . . , 404-n, where n is a positive integer greater than one, and one or more destination STAs dSTA_1, . . . , dSTA_m, where m is a positive integer. The rSTAs are located between the sSTA and the dSTA(s) and are configured to decode and forward data received from the sSTA to the dSTA(s). In the embodiment depicted in FIG. 4, each of the rSTAs is configured to independently decode and forward data received from a preceding STA to a next STA. The wireless DF single relay multi-hop communications system 400 can be used in various applications, such as industrial applications, medical applications, computer applications, and/or consumer or enterprise applications. In some embodiments, the wireless DF single relay multi-hop communications system 400 is compatible with an IEEE 802.11 protocol. In the embodiment depicted in FIG. 4, the sSTA 402 may be implemented the same as or similar to the AP 102, the rSTA 104 and/or the dSTA 106 depicted in FIG. 1, while the rSTAs 404-1, . . . , 404-n and the dSTA(s) dSTA_1, . . . , dSTA_m may be implemented the same as or similar to the rSTA 104 and the dSTA 106 depicted in FIG. 1, respectively.

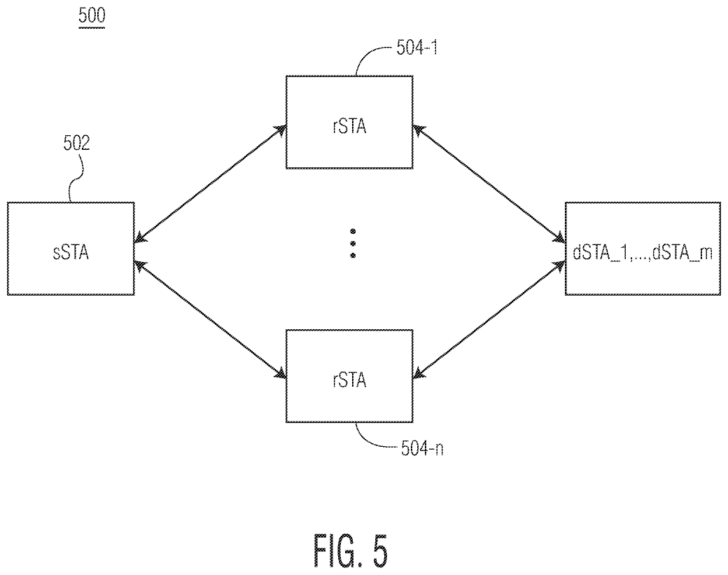

FIG. 5 depicts a wireless DF multi-relay cooperative communications system 500 in accordance with an embodiment of the invention. In the embodiment depicted in FIG. 5, the wireless DF multi-relay cooperative includes a source STA (sSTA) 502, relay stations (STAs) (rSTAs) 504-1, . . . , 504-n, where n is a positive integer greater than one, and one or more destination STAs dSTA_1, . . . , dSTA_m, where m is a positive integer. The rSTAs are located between the sSTA and the dSTA(s) and are configured to cooperatively decode and forward data received from the sSTA to the dSTA(s). The wireless DF multi-relay cooperative communications system 500 can be used in various applications, such as industrial applications, medical applications, computer applications, and/or consumer or enterprise applications. In some embodiments, the wireless DF multi-relay cooperative communications system 500 is compatible with an IEEE 802.11 protocol. In the embodiment depicted in FIG. 5, the sSTA 502 may be implemented the same as or similar to the AP 102, the rSTA 104 and/or the dSTA 106 depicted in FIG. 1, while the rSTAs 504-1, . . . , 504-n and the dSTA(s) dSTA_1, . . . , dSTA_m may be implemented the same as or similar to the rSTA 104 and the dSTA 106 depicted in FIG. 1, respectively.

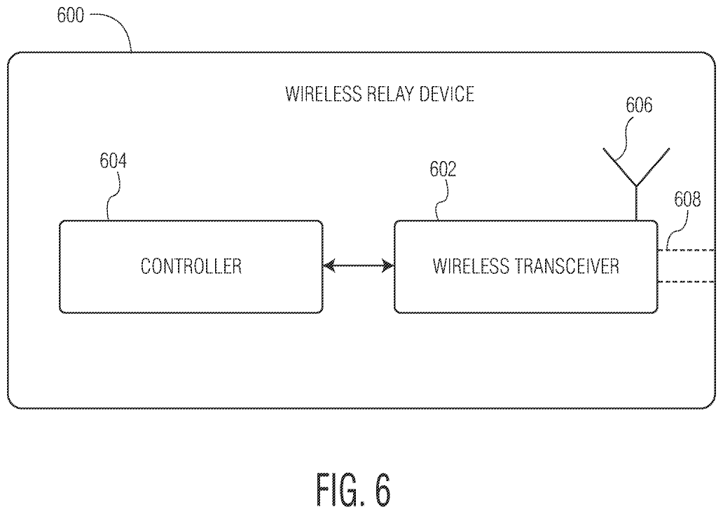

FIG. 6 depicts a wireless relay device 600 in accordance with an embodiment of the invention. The wireless relay device 600 can be used in the wireless communications system 100 depicted in FIG. 1, the wireless communications system 200 depicted in FIG. 2, the wireless DF relaying system 300 depicted in FIG. 3, the wireless DF single relay multi-hop communications system 400 depicted in FIG. 4, and the wireless DF multi-relay cooperative communications system 500 depicted in FIG. 5. For example, the wireless relay device 600 may be an embodiment of the rSTA 104 depicted in FIG. 1, the rSTAs 204-1, . . . , 204-n depicted in FIG. 2, the stations STA1, STA2, STA3, STA4, STA5 depicted in FIG. 3, the rSTAs 404-1, . . . , 404-n depicted in FIG. 4, and/or the rSTAs 504-1, . . . , 504-n depicted in FIG. 5. However, the rSTA 104 depicted in FIG. 1, the rSTAs 204-1, . . . , 204-n depicted in FIG. 2, the stations STA1, STA2, STA3, STA4, STA5 depicted in FIG. 3, the rSTAs 404-1, . . . , 404-n depicted in FIG. 4, and the rSTAs 504-1, . . . , 504-n depicted in FIG. 5 are not limited to the embodiment depicted in FIG. 6. In the embodiment depicted in FIG. 6, the wireless relay device 600 includes a wireless transceiver 602, a controller 604 operably connected to the wireless transceiver, and at least one antenna 606 operably connected to the wireless transceiver. In some embodiments, the wireless relay device 600 may include at least one optional network port 608 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless relay device 600 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with an embodiment of the invention, the wireless transceiver 602 is configured to receive, from a source wireless device, communications data, and the controller 604 is configured to decode and forward the received communications data to at least one destination wireless device. In some embodiments, the wireless relay device 600 (e.g., the wireless transceiver 602) shares a transmit opportunity (TXOP) of the source wireless device (i.e., the TXOP owned by the source wireless device) in a multi-hop transmission. The multi-hop transmission may be conducted through an aggregated PPDU. In some embodiments, the wireless relay device 600 (e.g., the controller 604) does not check frame check sequence (FCS) and forwards all MPDUs. In other embodiments, the wireless relay device 600 (e.g., the controller 604) checks FCS and only forwards correctly decoded MPDUs. In some embodiments, the wireless relay device 600 (e.g., the controller 604) provides relaying signaling in each PPDU to be relayed, and the relaying signaling is embedded in a PHY preamble or in a MAC header. The wireless relay device 600 may be compatible with an IEEE 802.11 protocol. In some embodiments, the wireless relay device 600 is a dedicated relay device. In some embodiments, the wireless relay device 600 a non-AP wireless station with a relaying function enabled. In some embodiments, the wireless relay device 600 is an AP with a relaying function enabled or a coordinated TXOP sharing function enabled.

Low-latency DF communications protocols can be implemented by defining a relay MAC/PHY protocol to enable low end-to-end latency and jitter, and better coexistence with existing single-hop Carrier Sense Multiple Access (CSMA). In some embodiments, in TXOP sharing relay communications, each hop's transmitter reserves TXOP for the following one or more relay hops, and shares the TXOP with the transmitter of the following hops. Each hop may set up its own BA or ACK agreement, or a source node and a destination node set up an end-to-end BA/ACK agreement.

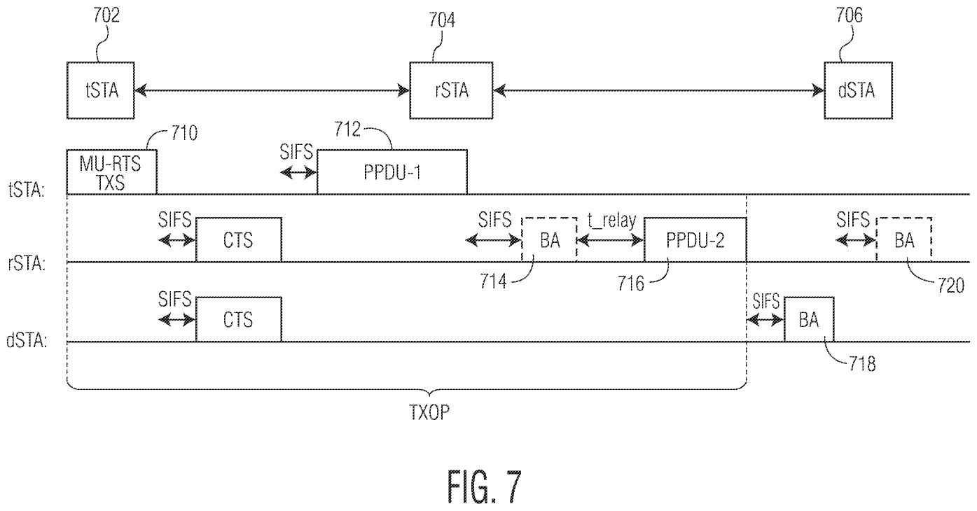

FIG. 7 depicts a frame exchange sequence diagram between a transmission station tSTA 702, a relay station rSTA 704, and a destination station dSTA 706 in accordance with an embodiment of the invention. In the embodiment depicted in FIG. 7, the tSTA 702 may be implemented the same as or similar to the AP 102, the rSTA 104 and/or the dSTA 106 depicted in FIG. 1, while the rSTA 704 and the dSTA 706 may be implemented the same as or similar to the rSTA 104 and the dSTA 106 depicted in FIG. 1, respectively. In the frame exchange sequence diagram depicted in FIG. 7, TXOP sharing relay communications with one relay are implemented. A Multi User Request to Send (MU-RTS) triggered TXOP sharing (TXS) frame 710 is sent by the tSTA 702 to reserve the TXOP for both hops (i.e., the tSTA 702 and the rSTA 704), and a portion of the TXOP is shared with the rSTA 704. For example, in the MU-RTS TXS frame, tSTA reserves a 5 milliseconds (ms) TXOP, out of which 3 ms is allocated to the rSTA, and the tSTA uses 2 ms for a Physical layer Protocol Data Unit (PPDU) PPDU-1 712 transmission. The rSTA 704 performs decoding and retransmission. The transmission of BA 714 from the rSTA back to the tSTA may be skipped if an end-to-end BA agreement is set up. The relay processing delay (t relay) is either pre-defined for any relays (e.g., being equal to SIFS), or per-determined by the rSTA. The rSTA retransmits successfully received MPDUs carried in PPDU-1 in a Physical layer Protocol Data Unit (PPDU) PPDU-2 716 to the dSTA 706. The dSTA 706 sends a BA 718 back to the rSTA, which may send an optional BA 720 back to the tSTA 702. PPDU2's Modulation and Coding Scheme (MCS)/number of spatial streams (NSS) may be informed to the tSTA with the information embedded in PPDU-1 or in a separate management frame. If the TXOP duration is not sufficient, the rSTA may choose to drop some MPDUs.

One or more examples of a relay's data transmission are described as follows. In some embodiments, in a relay's TXOP, the relay may also add its own traffic be transmitted to the dSTA or other STAs. In a relay's TXOP, the relay can also perform multi-user (MU) transmission by either MU multiple-input and multiple-output (MU-MIMO) or orthogonal frequency-division multiple access (OFDMA). This can be controlled by a source STA to allow a relay to add its own traffic, which can be used as a reward to encourage a STA to participate in relaying.

One or more examples of enhanced low-latency DF protocols are described as follows. In some embodiments, if an end-to-end BA/ACK agreement is set up, no BA is sent by the rSTA 704, PPDU-1 712 and PPDU-2 716 cascade in time. Aggregated PPDU mode can be further defined for relay transmission. For aggregated PPDU, in some embodiments, the tSTA 702 treats the multi-hop transmission as one, and decides the transmission parameters for all-hop PPDUs. In some embodiments, the rSTA 704 does not perform FCS check on a received PPDU, and retransmits all MPDUs such that the total PPDU duration is predictable at the tSTA 702. The tSTA 702 may not need MU-RTS to reserve TXOP. In some embodiments, the entire multi-hop aggregated PPDU is treated as “one giant PPDU”. In some embodiments, the Legacy Signal Field (L-SIG) length of the PPDU-1 712 indicates the duration of all aggregated PPDUs to protect the entire transmission.

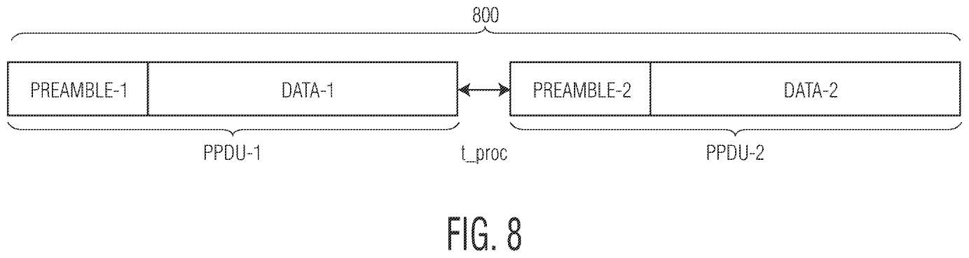

FIG. 8 depicts an aggregated PPDU 800 in accordance with an embodiment of the invention. As depicted in FIG. 8, the aggregated PPDU 800 includes a first PPDU PPDU-1, which includes a preamble Preamble-1 and a data field Data-1, and a second PPDU PPDU-2, which includes a preamble Preamble-2 and a data field Data-2. The following relayed PPDU preamble may only indicate the duration from current and all following PPDUs. The first PPDU PPDU-1 and the second PPDU PPDU-2 with a PPDU gap tproc is signaled as one PPDU. In some embodiments, the preamble Preamble-1 is a full preamble (Legacy preamble (e.g., legacy signal field (L-SIG)), Repeated Legacy Signal Field (RL-SIG), Universal Signal Field (U-SIG), Ultra High Reliability Signal Field (UHR-SIG), Ultra High Reliability-Short Training Field/Long Training Field (UHR-STF/LTF)). In some embodiments, communication protocols (e.g., IEEE 802.11a/b/g, IEEE 802.11n, IEEE 802.11ac, IEEE 802.11ax or IEEE 802.11be, IEEE 802.11ah/ad)) may be collectively referred to herein as “legacy” communication protocols. In some embodiments, L_LENGTH field in L-SIG of the preamble Preamble-1 signals the entire duration of PPDU-1+t_proc+PPDU-2. In some embodiments, the number of data symbols in Data-1 and/or Data-2 can be explicitly signaled in UHR-SIG. UHR-SIG may also include the modulation info for both Data-1 and Data-2, and may also include UHR-SIG MCS for PPDU-2. Two options of the preamble Preamble-2 are described as follows. In option 1, the preamble Preamble-2 is a full preamble with LLENGTH covering till the end of Data-2 (Legacy preamble, RL-SIG, U-SIG, UHR-SIG, UHR-STF/LTF). In option 2, the preamble Preamble-2 is a compressed preamble with better efficiency (e.g., a preamble with only selected sections but not all sections of a full preamble). In a first example, the preamble Preamble-2 is a combination of UHR-STF and UHR-LTF, i.e., fully rely on Preamble-1 for signaling of PPDU-2. In a second example, the preamble Preamble-2 is a combination of UHR-STF, UHR-LTF, and UHR-SIG, and Data-2 modulation information is signaled in UHR-SIG. In some embodiments, the PPDU gap tproc is used to accommodate hardware processing delay at the relay, packet extension (similar to IEEE 802.11ax/be) can be appended to PPDU-1 to cover the gap such that there is no gap without signal energy between two PPDUs. To reduce the capability signaling overhead, one fixed PE value can be defined to account for the worst case (e.g., 16 microsecond (μs) PE, 20 μs PE or longer).

In aggregated PPDU, relay MAC support can be implemented as follows. In some embodiments, most signaling and processing is done at the PHY layer, and relay MAC layer function can be significantly reduced. In some embodiments, a relay only needs to update the MAC header, e.g., the address fields, in a relayed PSDU. In some embodiments, a relay does not need to manage BA agreement, sequence number, encryption/decryption.

In some embodiments, a method uses one or more relay STAs to extend communication range and improve throughput. In some embodiments, the method involves multi-hop transmission in one TXOP shared by a source STA, which can provide or even guarantee lower latency. In some embodiments, the method includes an end-to-end sequence number space definition and an end-to-end BA feedback from a destination STA to a source STA. In some embodiments, the method includes an end-to-end security setup between a destination STA to a source STA. In some embodiments, multi-hop transmission is in the form of an aggregated PPDU. In some embodiments, the method uses an L-SIG LENGTH field of a first PPDU covering entire aggregated PPDU transmission, and a compressed preamble for relayed PPDUs. In some embodiments, the method uses packet extension to cover the gap between PPDUs. In some embodiments, the method involves the source STA determining the transmission parameters for all relayed transmission and signaling the parameters in the PPDU. In one embodiment, a relay STA does not check FCS and forwards all MPDUs. In another embodiment, a relay STA checks FCS and only forwards the correctly decoded MPDUs. In some embodiments, the method includes relaying signaling in each PPDU that needs to be relayed, where the relaying signal can be embedded in a PHY preamble or in a MAC header. In some embodiments, a relay STA is an IEEE 802.11 device. In one embodiment, the relay STA is a dedicated relay device serving long distance STAs. In another embodiment, the relay STA is a regular non-AP STA with the relaying function enabled. In another embodiment, the relay STA is an AP or uAP STA with the relaying function enabled or the coordinated TXOP sharing function enabled.

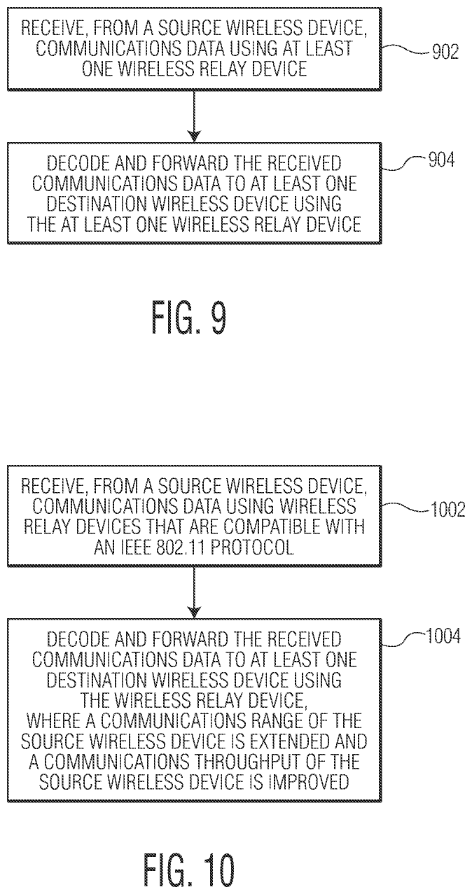

FIG. 9 is a process flow diagram of a method for wireless communications in accordance with an embodiment of the invention. At block 902, from a source wireless device, communications data is received using at least one wireless relay device. At block 904, the received communications data is decoded and forwarded to at least one destination wireless device using the at least one wireless relay device. In some embodiments, a transmit opportunity (TXOP) of the source wireless device (i.e., the TXOP owned by the source wireless device) is shared with the at least one wireless relay device. In some embodiments, an end-to-end sequence number space is defined and an end-to-end block acknowledgement (BA) feedback is provided from the destination wireless device to the source wireless device. In some embodiments, an end-to-end security setup is provided between the destination wireless device and the source wireless device. In some embodiments, the TXOP of the source wireless device is shared with the at least one wireless relay device in a multi-hop transmission, and the multi-hop transmission is conducted through an aggregated PPDU. In some embodiments, the aggregated PPDU includes a first PPDU and a second PPDU that is a relayed version of the first PPDU, a Legacy Signal Field (L-SIG) length of the first PPDU covers an entire aggregated PPDU transmission, and the second PPDU includes a compressed preamble. In some embodiments, the first PPDU is transmitted from the source wireless device to the at least one wireless relay device. In some embodiments, a packet extension is used to cover a gap between the first PPDU and the second PPDU. In some embodiments, at the source wireless device, transmission parameters for all relayed transmission are determined and the transmission parameters are signaled in a PPDU. In some embodiments, the at least one wireless relay device does not check FCS and forwards all MPDUs. In some embodiments, the at least one wireless relay device checks FCS and only forwards correctly decoded MPDUs. In some embodiments, relaying signaling is provided in each PPDU to be relayed, and the relaying signaling is embedded in a PHY preamble or in a MAC header. In some embodiments, the at least one wireless relay device is compatible with an IEEE 802.11 protocol. In some embodiments, the at least one wireless relay device includes a dedicated relay device. In some embodiments, the at least one wireless relay device includes a non-AP wireless station with a relaying function enabled. In some embodiments, the at least one wireless relay device includes an AP with a relaying function enabled or a coordinated TXOP sharing function enabled. In some embodiments, a communications range of the source wireless device is extended and a communications throughput of the source wireless device is improved. The source wireless device may be the same as or similar to the AP 102 depicted in FIG. 1, the AP 202 depicted in FIG. 2, the AP 302 depicted in FIG. 3, the sSTA 402 depicted in FIG. 4, the sSTA 502 depicted in FIG. 5, and the tSTA 702 depicted in FIG. 7. The at least one wireless relay device may be the same as or similar to the rSTA 104 depicted in FIG. 1, the rSTAs 204-1, . . . , 204-n depicted in FIG. 2, the stations STA1, STA2, STA3, STA4, STA5 depicted in FIG. 3, the rSTAs 404-1, . . . , 404-n depicted in FIG. 4, the rSTAs 504-1, . . . , 504-n depicted in FIG. 5, and the rSTA 704 depicted in FIG. 7. The at least one destination wireless device may be the same as or similar to the dSTA 106 depicted in FIG. 1, the dSTAs 206-1, . . . , 206-m depicted in FIG. 2, the station STA5 depicted in FIG. 3, the dSTA(s) dSTA_1, . . . , dSTA_m depicted in FIG. 4, the dSTA(s) dSTA_1, . . . , dSTA_m depicted in FIG. 5, and the dSTA 706 depicted in FIG. 7.

FIG. 10 is a process flow diagram of a method for wireless communications in accordance with an embodiment of the invention. At block 1002, from a source wireless device, communications data is received using wireless relay devices that are compatible with an IEEE 802.11 protocol. At block 1004, the received communications data is decoded and forwarded to at least one destination wireless device using the wireless relay devices, where a communications range of the source wireless device is extended and a communications throughput of the source wireless device is improved. In some embodiments, a TXOP of the source wireless device (i.e., the TXOP owned by the source wireless device) is shared with the wireless relay devices. In some embodiments, an end-to-end sequence number space is defined between the destination wireless device and the source wireless device and an end-to-end block acknowledgement (BA) agreement is set up between the destination wireless device and the source wireless device. In some embodiments, an end-to-end security setup is provided between the destination wireless device and the source wireless device. In some embodiments, the TXOP of the source wireless device is shared with the wireless relay devices in a multi-hop transmission, and the multi-hop transmission is conducted through an aggregated PPDU. In some embodiments, the aggregated PPDU includes a first PPDU and a second PPDU that is a relayed version of the first PPDU, a Legacy Signal Field (L-SIG) length of the first PPDU covers an entire aggregated PPDU transmission, and the second PPDU includes a compressed preamble. In some embodiments, the first PPDU is transmitted from the source wireless device to the wireless relay devices. In some embodiments, a packet extension is used to cover a gap between the first PPDU and the second PPDU. In some embodiments, at the source wireless device, transmission parameters for all relayed transmission are determined and the transmission parameters are signaled in a PPDU. In some embodiments, the wireless relay devices do not check FCS and forward all MPDUs. In some embodiments, the wireless relay devices check FCS and only forward correctly decoded MPDUs. In some embodiments, relaying signaling is provided in each PPDU to be relayed, and the relaying signaling is embedded in a PHY preamble or in a MAC header. In some embodiments, the wireless relay devices are compatible with an IEEE 802.11 protocol. In some embodiments, the wireless relay devices include a dedicated relay device. In some embodiments, the wireless relay devices include a non-AP wireless station with a relaying function enabled. In some embodiments, the wireless relay devices include an AP with a relaying function enabled or a coordinated TXOP sharing function enabled. The source wireless device may be the same as or similar to the AP 102 depicted in FIG. 1, the AP 202 depicted in FIG. 2, the AP 302 depicted in FIG. 3, the sSTA 402 depicted in FIG. 4, the sSTA 502 depicted in FIG. 5, and the tSTA 702 depicted in FIG. 7. The wireless relay devices may be the same as or similar to the rSTA 104 depicted in FIG. 1, the rSTAs 204-1, . . . , 204-n depicted in FIG. 2, the stations STA1, STA2, STA3, STA4, STA5 depicted in FIG. 3, the rSTAs 404-1, . . . , 404-n depicted in FIG. 4, the rSTAs 504-1, . . . , 504-n depicted in FIG. 5, and the rSTA 704 depicted in FIG. 7. The at least one destination wireless device may be the same as or similar to the dSTA 106 depicted in FIG. 1, the dSTAs 206-1, . . . , 206-m depicted in FIG. 2, the station STA5 depicted in FIG. 3, the dSTA(s) dSTA_1, . . . , dSTA_m depicted in FIG. 4, the dSTA(s) dSTA_1, . . . , dSTA_m depicted in FIG. 5, and the dSTA 706 depicted in FIG. 7.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless relay device comprising:
a wireless transceiver configured to receive, from a source wireless device, communications data; and
a controller configured to decode and forward the received communications data to at least one destination wireless device.

2. The wireless relay device of claim 1, wherein the wireless transceiver is further configured to share a transmit opportunity (TXOP) of the source wireless device.

3. The wireless relay device of claim 2, wherein the wireless transceiver is further configured to share the TXOP of the source wireless device in a multi-hop transmission, wherein the multi-hop transmission is conducted through an aggregated physical layer protocol data unit (PPDU).

4. The wireless relay device of claim 3, wherein the aggregated PPDU comprises a first PPDU and a second PPDU that is a relayed version of the first PPDU, wherein a Legacy Signal Field (L-SIG) length of the first PPDU covers an entire aggregated PPDU transmission, and wherein the second PPDU comprises a compressed preamble.

5. The wireless relay device of claim 1, wherein the controller is further configured to forward all Media Access Control (MAC) protocol data units (MPDUs) without checking frame check sequence (FCS).

6. The wireless relay device of claim 1, wherein the controller is further configured to check frame check sequence (FCS) and only forward correctly decoded Media Access Control (MAC) protocol data units (MPDUs).

7. The wireless relay device of claim 1, wherein the wireless relay device is compatible with an IEEE 802.11 protocol.

8. The wireless relay device of claim 7, wherein the wireless relay device is a dedicated relay device.

9. The wireless relay device of claim 7, wherein the wireless relay device is a non-access point (AP) wireless station with a relaying function enabled.

10. The wireless relay device of claim 7, wherein the wireless relay device is an access point (AP) with a relaying function enabled or a coordinated transmit opportunity (TXOP) sharing function enabled.

11. A method for wireless communications, the method comprising:
receiving, from a source wireless device, communications data using at least one wireless relay device; and
decoding and forwarding the received communications data to at least one destination wireless device using the at least one wireless relay device.

12. The method of claim 11, further comprising sharing a transmit opportunity (TXOP) of the source wireless device with the at least one wireless relay device in a multi-hop transmission.

13. The method of claim 11, further comprising setting up an end-to-end block acknowledgement (BA) agreement between the destination wireless device and the source wireless device, including defining an end-to-end sequence number space between the destination wireless device and the source wireless device.

14. The method of claim 12, further comprising providing an end-to-end security setup between the destination wireless device and the source wireless device.

15. The method of claim 12, wherein the multi-hop transmission is conducted through an aggregated physical layer protocol data unit (PPDU), wherein the aggregated PPDU comprises a first PPDU and a second PPDU that is a relayed version of the first PPDU, wherein a Legacy Signal Field (L-SIG) length of the first PPDU covers an entire aggregated PPDU transmission, and wherein the second PPDU comprises a compressed preamble.

16. The method of claim 15, wherein the first PPDU is transmitted from the source wireless device to the at least one wireless relay device.

17. The method of claim 15, further comprising using a packet extension to cover a gap between the first PPDU and the second PPDU.

18. The method of claim 11, further comprising at the source wireless device, determining a plurality of transmission parameters for all relayed transmission and signaling the transmission parameters in a physical layer protocol data unit (PPDU).

19. The method of claim 11, further comprising providing relaying signaling in each physical layer protocol data unit (PPDU) to be relayed, and wherein the relaying signaling is embedded in a physical layer (PHY) preamble or in a Media Access Control (MAC) header.

20. A method for wireless communications, the method comprising:
receiving, from a source wireless device, communications data using a plurality of wireless relay devices that are compatible with an IEEE 802.11 protocol; and
decoding and forwarding the received communications data to at least one destination wireless device using the wireless relay devices, wherein a communications range of the source wireless device is extended and a communications throughput of the source wireless device is improved.
